(19) United States
(12) Patent Application Publication
(10) Pub. No.: US 2010/0191671 A1
(43) Pub. Date: Jul. 29, 2010

(54) METHODS AND SYSTEMS FOR PROVIDING A MUNICIPAL INDEX SWAP

(75) Inventors: Peter E. Coleman, Garden City, NY (US); Peter J. DeGroot, Oceanside, NY (US); Richard Scott Lohan, Cold Spring Harbor, NY (US); James Vergara, New York, NY (US); Jonathan Debrich, Woodside, NY (US); Akshay Locharla Murthy, New York, NY (US); Daniel Singer, New York, NY (US)

Correspondence Address: Morgan Lewis & Bockius LLP, 1701 Market Street, Philadelphia, PA, 19103, US

(73) Assignee: Barclays Capital Inc., New York, NY (US)

(21) Appl. No.: 12/323,859

(22) Filed: Nov. 26, 2008

Related U.S. Application Data
(60) Provisional application No. 60/992,563, filed on Dec. 5, 2007.

(51) Int. Cl. G06Q 40/00

(52) U.S. Cl. 705/36 T; 705/37; 705/35

(57) ABSTRACT

In at least one aspect the invention comprises a computer-implemented method comprising: (a) electronically receiving data regarding characteristics of a plurality of tax exempt municipal bonds; (b) electronically receiving data describing a plurality of rules for inclusion of the tax exempt municipal bonds in a municipal bond index; (c) constructing a municipal bond index by applying the rules to characteristics of the plurality of tax exempt municipal bonds; and (d) quoting a municipal swap having a reference index, wherein the reference index is the municipal bond index. Other aspects comprise related computer systems and apparatuses, as well as various embodiments.

### CROSS REFERENCE TO RELATED APPLICATIONS

This application claims priority to U.S. Provisional Patent Application No. 60/992,563, fled Dec. 5, 2007. The entire contents of that provisional application are incorporated herein by reference.

### INTRODUCTION

The fixed-income capital markets have undergone a broad transformation due to the widespread acceptance and implementation of derivative products, such as rules-based total return indices. These indices are increasingly utilized as reference items in both fixed-income and commodity-based derivative products.

Municipal structured products have also experienced rapid expansion over the past few years. The development of the municipal structured products market coincides with the increased penetration of municipal securities in global asset allocation strategies. However, the lack of investor confidence in a high-grade cash market reference curve has discouraged further participation in the municipal derivative market. Current reference curves are perceived to inadequately represent the movement of securities in the cash portion of the market.

Exemplary embodiments of Municipal Index Swaps (MIS) of the present invention facilitate trading in high quality sectors of the municipal market. These products offer scalable access to the municipal market without the need for security specific analysis. MIS are based on an agreement to either go long or short the yield on a specific Municipal Bond Index over a specified period of time. A swap is an over-the-counter contract between two parties and is an unfunded transaction. The swap structure gives the receiver (long position) the economics of the Reference Index without actually owning the underlying assets.

Exemplary MIS described herein are Municipal Index Swap General Obligation 5-Year (MISGO5), Municipal Index Swap General Obligation 10-Year (MISGO10), Index Swap Intermediate (MISINT), and Swap Long (MISLNG) indices.

There are novel aspects of embodiments described herein, comprising swaps performed using a municipal entity as a reference item. The first aspect relates to the reference index and the manner in which it is constructed. The second aspect relates to the manner in which the municipal swap is performed or, more specifically, the quoting of municipal swaps on a total return basis relative to a published municipal benchmark.

Both the indices and swap terms are described herein. There are additional novel aspects regarding the specific index rules (factors and values for selecting and weighting index constituents).

In an exemplary embodiment, a municipal swap reference item with a rules based municipal index construction methodology which includes municipal securities is based on one or more of the following bond characteristics:
final maturity or prerefunded date
market sector
credit quality
size of security or deal
issuer concentration
coupon level or frequency
tax-status
cash flow features

Currently, it is common practice in the municipal market to enter into swap contracts based upon a rate lock format. A rate lock is an agreement to pay or receive the difference in the change in yield, with or without a spread adjustment, of one reference index versus another. The market has yet to trade a municipal based reference entity based on the change or cumulative total return of a published municipal based reference entity.

In one aspect, the invention comprises a computer-implemented method comprising: (a) electronically receiving data regarding characteristics of a plurality of tax exempt municipal bonds; (b) electronically receiving data describing a plurality of rules for inclusion of the tax exempt municipal bonds in a municipal bond index; (c) constructing a municipal bond index by applying the rules to characteristics of the plurality of tax exempt municipal bonds; and (d) quoting a municipal swap having a reference index, wherein the reference index is the municipal bond index.

In another aspect, the invention comprises a computer system comprising: (a) a hardware component that electronically receives data regarding characteristics of a plurality of tax exempt municipal bonds; (b) a hardware component that electronically receives data describing a plurality of rules for inclusion of the tax exempt municipal bonds in a municipal bond index; (c) a hardware component that constructs a municipal bond index by applying the rules to characteristics of the plurality of tax exempt municipal bonds; and (d) a hardware component that quotes a municipal swap having a reference index, wherein the reference index is the municipal bond index, and wherein the hardware components may be, but are not necessarily, distinct from each other.

In another aspect, the invention comprises an apparatus comprising: (a) a first computer readable medium that stores data regarding characteristics of a plurality of tax exempt municipal bonds; (b) a second computer readable medium that stores data describing a plurality of rules for inclusion of the tax exempt municipal bonds in a municipal bond index; (c) a third computer readable medium that stores data describing a municipal bond index constructed by applying the rules to characteristics of the plurality of tax exempt municipal bonds; and (d) a fourth computer readable medium that stores one or more quotes regarding a municipal swap having a reference index, wherein the reference index is the municipal bond index, and wherein the computer readable mediums may be, but are not necessarily, distinct from each other.

In various embodiments: (1) the swap is on a total return basis; (2) the rules comprise tax status; (3) the tax status relates to exemption from alternative minimum tax; (4) the swap is on a yield basis; (5) the municipal bond index comprises two sets of municipal bonds: a returns universe and a statistics universe; (6) the returns universe is adjusted only on a monthly basis; (7) the returns universe comprises municipal bonds whose value determines a value for the reference index; (8) composition of the statistics universe changes on a daily basis; (9) composition of the statistics universe accounts for changes due to one or more of new issuance, calls, rating changes, and remaining maturity; and (10) at the end of each month, the current statistics universe becomes the returns universe for the coming month.

### BRIEF DESCRIPTION OF THE DRAWINGS

FIG. 1 illustrates a relationship between current (returns) and next month's (statistics) universes.

FIG. 2 depicts a computer based system for processing data according to an embodiment of the invention.

### DETAILED DESCRIPTION OF EMBODIMENTS

Exemplary embodiments of the present invention are described in detail below.

Utilizing a benchmark as part of an investment discipline enhances diversification of assets, discourages wholesale duration bets, provides objective performance measurement, encourages stable returns, and fosters efficient transaction management. A well-designed benchmark preferably has the following attributes:
Universe is well defined.
Securities are investable.
Current characteristics are available (e.g. yield, price, coupon, duration, etc.).
Historical information is accessible.
Rules are objective and well understood. Performance is a reliable reflection of market performance.
Weightings are based on market value outstanding.
Risk characteristics are stated in advance of performance period.

In an embodiment, a Municipal Index Swap uses a rules-based methodology. That is, to be included in the index a security must meet certain eligibility requirements. A well defined set of rules minimizes arbitrary exclusion of securities, ensures that the issues included have reasonable trading availability, and allows for maintenance of complete market data. This approach ensures that the Municipal Bond Index Swap of an embodiment is consistent, objective, replicable, reliable, and representative of the marketplace. Moreover, the index is unbiased, in that subjective factors do not enter into the selection process.

### Exemplary Embodiments

(1) Municipal Index Swap-GO 5-Year—(MISGO5)
All Municipal bonds that comply with the following are eligible for inclusion in a 5-year GO (Aa3 or better) Municipal Bond Index Swap:
General Obligation classification, excluding insured and pre-refunded bonds.
Quality AA-/Aa3 or better.
Deal size over $75 million.
Maturity size of at least $7 million.
Dated date within 10-years.
Maturity of greater than 4-years and less than 6-years (4-5.999).
10% maximum issuer concentration.
Fixed coupon rate, excluding zeros.
Tax-Exempt/No AMT.
No secondary insured or private placement bonds.
No sinking funds.
Non-callable.

(2) Municipal Index Swap-GO 10-Year—(MISG10)
All Municipal bonds that comply with the following are eligible for inclusion in the 10-year GO (Aa3 or better) Municipal Bond Index Swap:
General Obligation classification, excluding insured and prerefunded bonds.
Quality AA-/Aa3 or better.
Deal size over $75 million.
Maturity size of at least $7 million.
Dated date within 10-years.
Maturity of greater than 8-years and less than 12-years (8-11.999).
10% maximum issue concentration.
Fixed coupon rate, excluding zeros.
Tax-Exempt/No AMT.
No secondary insured or private placement bonds.
No sinking funds.
Non-callable or minimum 7-years call protection.

(3) Municipal Index Swap-Intermediate—(MISINT)
All Municipal bonds that comply with the following are eligible for inclusion in the Intermediate (Aa3 or better) Municipal Bond Index Swap:
Deal Size over $75 million.
Maturity size of at least $7 million.
Tax-exempt/no AMT.
Excluding Housing, Hospital, and Leasing bonds.
Excluding airline and tobacco bonds.
Quality: not insured—AA-/Aa3 or better; insured—underlying A-/A3.
Dated date within 10-years.
Price of greater than and equal to 90 and less than and equal to 120.
Fixed coupon rate, excluding zeroes.
No secondary insured or private placement bonds.
No sinkers/callables within 7 years.
Maturity of greater than and equal to 8-years and less than 20-years [8, 20).
10% maximum issuer concentration.

(4) Municipal Index Swap-Long—(MISLNG)
All Municipal bonds that comply with the following are eligible for inclusion in the Long (Aa3 or better) Municipal Bond Index Swap:
Deal Size over $75 million.
Maturity size of at least $7 million.
Tax-exempt/no AMT.
Excluding Housing, Hospital, and Leasing bonds.
Excluding airline and tobacco bonds.
Quality: not insured—AA-/Aa3 or better; insured—underlying A-/A3.
Dated date within 10-years.
Price of greater than and equal to 90 and less than and equal to 120.
Fixed coupon rate, excluding zeroes.
No secondary insured or private placement bonds.
Sinkers/callables within 7 years.
Maturity of greater than and equal to 20-years and less than 35-years [20, 35).
10% maximum issuer concentration.
All securities in the Municipal Index Swap GO 5-Year (MISGO5) and Municipal Index Swap GO 10-Year (MISGO10) benchmarks preferably are general obligation (GO) bonds. A general obligation bond is a security that is backed by the full faith, credit and taxation powers of the issuer. GO bonds are further classified into State and Local. For example, a New York State GO bond is backed by the various taxes that the state levies. These taxes include income taxes, sales taxes, and excise taxes. Counties and cities tend to rely on property taxes for their GO bonds. The tax base of the issuing entity and its discretion are important factors in determining the pricing of GO bonds. For example, certain school districts and counties have a limit on the level of tax they may charge their residents. The tax base of the issuing city, growth rate of the local economy, property values, existing or outstanding debt obligations, and per capita debt are all important factors in judging the financial soundness of a GO bond. The MISGO5 and MISGO10 indicators preferably do not include insured, revenue, pre-refunded, or double-barreled securities.

The tax-exempt bond market is one in which the interest from bonds that are issued and sold is exempt from federal income taxation, and may be exempt from state and local taxation. Capital gains, however, are still subject to the normal taxation rules that are applicable. States, municipalities, and counties raise the capital they need by issuing debt securities referred to as municipal debt securities. Since the majority of municipal debt securities are tax-exempt, the terms municipal market and tax-exempt market are used interchangeably.

The municipal bond universe is a large, diverse, complex marketplace comprising an extremely large number of issues with relatively low market value. Other fixed income asset classes are larger on a market value basis; however, they do not have as many issues as the tax-exempt market. The large number of issues in the tax-exempt market enhances an investor's ability to diversify by credit quality, sector, and geographical location.

As of Dec. 31, 2006, the municipal market contained approximately $2.5 trillion in bonds outstanding and was represented by more than 150,000 issuers. Over the last 25 years, the total issuance of municipal bonds has increased dramatically as a result of increased demand for public services, reduced federal funding, and fiscal limitations on pay-as-you-go funding of capital outlays. Another contributing factor has been the development of creative new uses for tax-exempt bonds by bond lawyers, public officials, and investment bankers. In 1980 the total new issuance of municipal bonds was $48.4 billion. In the years 2002-2006, an average of over $372.1 billion worth of new municipal bonds was issued each year; a record $408 billion was issued in 2005.

Current (Returns) and Next Month (Statistics) Universe

Each index of an embodiment comprises two universes of securities. The securities that are reference assets for the current month are based on a set of bonds determined at the beginning of the month and held constant until the beginning of the next month. This current (returns) universe is not adjusted for securities that become ineligible for inclusion in the index during the month (e.g., due to downgrades, called bonds, or securities falling below the maturity range), or for newly eligible issues (e.g., upgrades, newly issued bonds). The swap index performance numbers reflect the performance of the current universe over the specified holding period. By holding the universe constant throughout a month, the investor avoids having to account for a moving benchmark and is able to rebalance at the end of the month. The current (returns) universe represents the securities that are valued for all swap transactions.

Next month's (statistics) universe is a dynamic set of bonds that changes daily to reflect the latest composition of the index. This universe accounts for changes due to new issuance. calls, rating changes, and remaining maturity. Changes due to new issuance, calls, or partial redemptions occur as of settlement date. Statistics such as market values, sector weightings, and various averages (e.g., coupon, duration, maturity, yield, price, etc.) are updated and reported daily. The statistics universe is not used as the reference asset for the swap. This basket is disclosed to provide insight into next month's swap index. At the end of each month, the latest statistics universe becomes the current universe for the coming month. The statistics universe allows investors to monitor changes in the index in advance of the index rebalance at month end. Active traders can modify their swaps as the index changes in preparation for the new index at the end of the month.

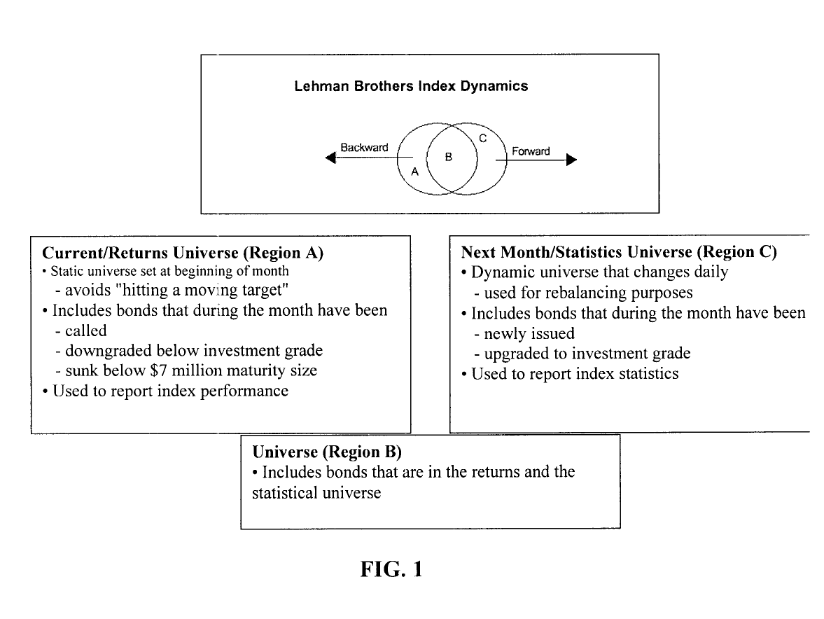

The relationship between the current (returns) and next month's (statistics) universes during a month can be represented by two overlapping circles (see FIG. 1). Circle 1 (area A) is the current universe during the month. Circle 2 (area C) is the statistics universe during the month. Area B denotes securities that are in both returns and statistics universes. Area A represents securities that have dropped out of the statistics universe during the month but remain in the returns universe, and Area C is new additions to the statistics universe that will be part of the returns universe beginning with the next month.

Municipal Index results preferably are reported on a daily, month-to-date, monthly, annual, and since-inception basis. Performance is cumulative for the entire period. Intra-month cash flows contribute to monthly performance, but are not reinvested during the month and do not earn a reinvestment return. They are reinvested into the returns universe for the following month. Thus, index results over two or more months reflect monthly compounding.

Market Weighting—yield and most summary statistics are fully market value weighted at the beginning of the period.

Transaction Formats

The indices of the above embodiments may be quoted and traded in one of two formats: a rate lock agreement and a total return basis. Exemplary details of these swap types are in provided in Appendix A and Appendix B below. Those skilled in the art will recognize, however, that other formats could be used with the present invention without departing from the scope of the invention.

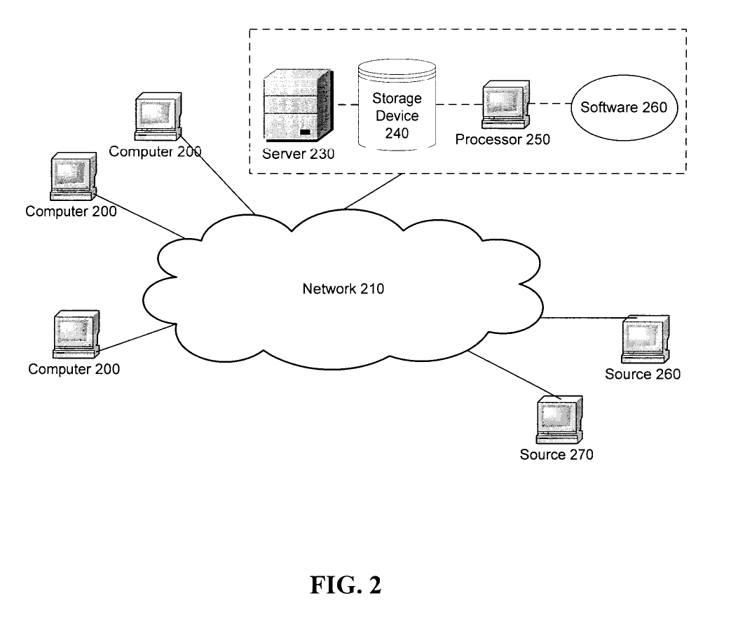

Embodiments of the present invention comprise computer components and computer-implemented steps that will be apparent to those skilled in the art. For example, calculations and communications can be performed electronically. An exemplary system is depicted in FIG. 2. As shown, computers 200 communicate via network 210 with a central server 230. A plurality of sources of data 260, 270 relating to, for example, trading volume data, also communicate via network 210 with a central server 230, processor 250, and/or other component to calculate and transmit, for example, volume forecast data. The server 230 may be coupled to one or more storage devices 240, one or more processors 250, and software 260.

Other components and combinations of components may also be used to support processing data or other calculations described herein as will be evident to those skilled in the art. Server 230 may facilitate communication of data from a storage device 240 to and from processor 250, and communications to computers 200. Processor 250 may optionally include local or networked storage (not shown) which may be used to store temporary information. Software 260 can be installed locally at a computer 200, processor 250 and/or centrally supported for facilitating calculations and applications.

For ease of exposition, not every step or element of the present invention is described herein as part of a computer system and/or software, but those skilled in the art will recognize that each step or element may have (and typically will have) a corresponding computer system or software component. Such computer system and/or software components are therefore enabled by describing their corresponding steps or elements (that: is, their functionality), and are within the scope of the present invention.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of, or all of, the processors specified in the description and/or claims could be the same processor. All such combinations are within the scope of the invention.

The present invention has been described by way of example only, and the invention is not limited by the specific embodiments described herein. As will be recognized by those skilled in the art, improvements and modifications may be made to the invention and the illustrative embodiments described herein without departing from the scope or spirit of the invention.

### APPENDIX A

### Municipal Index Swap—Rate Lock Format

### Sample: Indicative Terms and Conditions

### Date: Trade Date

### To: Party B

### From: Party A

### SUBJECT: SWAP TRANSACTION (Ref: Trade ID)

The purpose of this communication is to set forth the terms and conditions of the swap transaction entered into on the Trade Date referred to below (the “Swap Transaction”), between “Party A” and “Party B”. This communication constitutes a “Confirmation” as referred to in the Swap Agreement specified below.

This Confirmation supplements, forms part of, and is subject to, the ISDA Master Agreement dated as of ‘date’, as amended and supplemented from time to time, between Party A and Party B (the “Swap Agreement”). All provisions contained in, or incorporated by reference to, such Swap Agreement shall govern this Confirmation except as expressly modified below.

Party A and Party B each represents that entering into this Transaction is authorized and does not violate any laws of its jurisdiction of organization or residence, or the terms of any agreement to which it is a party. Party A and Party B each represents that (i) it is not relying on the other party in connection with its decision to enter into this Transaction and neither party is acting as an advisor to or fiduciary of the other party in connection with this Transaction regardless of whether the other party provides it with market information or its views; (ii) it understands the risks of this Transaction and any legal, regulatory, tax, accounting and economic consequences resulting therefrom; and (iii) it has determined based upon its own judgment and upon any advice received from its own professional advisors as it has deemed necessary to consult that entering into this Transaction is appropriate for such party in light of its financial capabilities and objectives. This Confirmation incorporates the definitions and provisions contained in the 2000 ISDA Definitions as published by the International Swaps and Derivatives Association, Inc. (the “Definitions”). In the event of any inconsistency between the Definitions and this Confirmation, this Confirmation will govern

The terms of the particular Swap Transaction to which this communication relates are as follows:

| | |
|---|---|
| Trade Date: | T |
| Termination | T + 3-months (term) subject to |
| Date: | adjustment in accordance with the |
| | Modified Following Business Day Convention |
| Notional Amount: | Min $10 mm |
| INDEX | |
| FLOATING AMOUNT: | |
| Index Floating | Party A |
| Rate Payer | |
| Index Floating | T + 3-months (term) subject to |
| Rate Payer | adjustment in accordance with the |
| Payment Dates: | Modified Following Business Day |
| | Convention |
| Floating Index: | MIS Index: Municipal Swap Index |
| | as published by with security prices |
| | provided by Interactive Data Corporation |
| | (IDC). In the event that IDC does not |
| | provide the necessary data and Publisher |
| | does not publish the Index on the Reset |
| | Date, Party A shall determine the |
| | MIS Index in a commercially reasonable |
| | manner. |
| PVO1: | TBD |
| Fixed Rate: | TBD |
| Index Floating | For the Calculation Period, the Index |
| Amount: | Floating Amount is: |
| | [Locked rate − MIS rate at termination] × |
| | 100 × Notional Amount/1000 × DVO1 |
| | If the Index Floating Amount for the |
| | Calculation Period is a positive number |
| | Party A will pay such amount to Party B. |
| | If the Index Floating Amount is a negative |
| | number Party B will pay the absolute value |
| | of such amount to Party A. |
| Designated | 10 Years (MISGO10) |
| Maturity: | |
| Spread: | None |
| Reset Date | The close of business on ‘date’ |
| Other Provisions | |
| Calculation Agent: | Party A, or as specified in the Swap Agreement |
| Business Days: | New York |
| Account details: | |
| Account for payment | Bank information. |
| to Party A in: | |
| Account for Payment | Bank information. |
| to Party B in: | |

### APPENDIX B

### Municipal Index Swap—TOTAL RETURN FORMAT

### Date: [Date of Confirmation]

### To: [Counterparty Contact Name]

From: [Entity of]
Ref. Numbers: Risk ID: TBD/Effort ID: TBD/Global Deal ID: TBD

The purpose of this communication (this “Confirmation”) is to confirm the terms and conditions of the transaction (the “Transaction”) entered into between [Entity] (“Party A”) and [Counterparty Entity] (“Party B”) on the Trade Date specified below. This Confirmation constitutes a “Confirmation” as referred to in the Agreement specified below.

This Confirmation supplements, forms part of, and is subject to, the ISDA Master Agreement dated as of ______, as amended and supplemented from time to time, between Party A and Party B (the “Agreement”). All provisions contained in the Agreement shall govern this Confirmation except as expressly modified below.

The definitions and provisions contained in the 2000 ISDA Definitions as published by the International Swaps and Derivatives Association, Inc. (the “Definitions”) are incorporated into this Confirmation. In the event of any inconsistency between the Definitions and the terms of this Confirmation, this Confirmation will govern. For the purpose of the Definitions, references herein to a “Transaction” shall be deemed to be references to a “Swap Transaction”.

Party A and Party B each represents that entering into the Transaction is within its capacity, is duly authorized and does not violate any laws of its jurisdiction of organization or residence or the terms of any agreement to which it is a party. Party A and Party B each represents that (a) it is not relying on the other party in connection with its decision to enter into this Transaction, and neither party is acting as an advisor to or fiduciary of the other party in connection with this Transaction regardless of whether the other party provides it with market information or its views; (b) it understands the risks of the Transaction and any legal, regulatory, tax, accounting and economic consequences resulting therefrom; and (c) it has determined based upon its own judgment and upon any advice received from its own professional advisors as it has deemed necessary to consult that entering into the Transaction is appropriate for such party in light of its financial capabilities and objectives. Party A and Party B each represents that upon due execution and delivery of this Confirmation, it will constitute a legally valid and binding obligation, enforceable against it in accordance with its terms, subject to applicable principles of bankruptcy and creditors' rights generally and to equitable principles of general application.

The terms of the particular Transaction to which this Confirmation relates are as follows:

General Terms:

| | |
|---|---|
| General Terms: | |
| Trade Date: | T |
| Effective Date: | TBD |
| Termination | T + 3 month (term) subject to adjustment |
| Date: | in according with the Modified Following |
| | Business Day Convention |
| Notional Amount: | |
| Index Floating | |
| Amounts: | |
| Index Floating | For each Calculation Period, the product of (i) |
| Amount: | the Notional Amount multiplied by (ii) the |
| | difference of (x) the Bond Index Ratio for such |
| | Calculation Period, minus (y) one |
| Index Floating | If the Index Floating Amount for a Calculation |
| Amount Payer: | Period is a positive number, Party A shall pay |
| | such amount to Party B on the Index Floating |
| | Amount Payment Date. If the Index Floating |
| | Amount for a Calculation Period is a negative |
| | number, Party B shall pay the absolute value |
| | of such amount to Party A, in addition to |
| | the Party B Floating Amount for such |
| | Calculation Period on the Index Floating |
| | Amount Payment Date. |
| Index Floating | T + 3-months (term) subject to adjustment in |
| Amount Payer | accordance with the Modified Following Business |
| Period End Dates: | Day Convention |
| No Adjustment of | Applicable |
| Period End Dates: | |
| Delayed Payment: | 4 calendar days after each Index Floating Amount |
| | Payer Period End Date, subject to adjustment in |
| | accordance with the Modified Following Business |
| | Day Convention. |
| Bond Index | For each Calculation Period, the quotient of (I) |
| Ratio: | the Bond Index as of one Business Day prior to |
| | the Index Floating Amount Payer End Date divided |
| | by (ii) the Bond Index as of one Business Day |
| | prior to the Index Floating Amount Period End |
| | Date of the previous Calculation Period. |
| | For the initial Calculation Period, the Bond |
| | Index Ratio will utilize the Index close as of |
| | [TBD date], as (ii) in the above calculation. |
| | For the final Calculation Period, the Bond Index |
| | Ratio will utilize the Index close as of |
| | [TBD date] as (i) in the above calculation. |
| Bond Index: | 100 plus the total return since inception of the |
| | Municipal Index Swap as published on page [ ] by |
| | Bloomberg Financial Services, Inc. (“Bloomberg”) |
| | under the captions Municipal, Muni Swap Aa3 Plus |
| | GO. |
| | MIS Index: Municipal Swap Index as published by |
| | [publisher] with security prices provided |
| | by Interactive Data Corporation (IDC). In the |
| | event that IDC does not provide the necessary |
| | data and publisher does not publish the Index |
| | on the Reset Date, Party A shall determine the |
| | MIS Index in a commercially reasonable manner. |
| Correction | If, in respect of this Transaction, the Bond Index |
| of Index: | published on a given day and used or to be used by |
| | the Calculation Agent to determine the Bond Index |
| | Ratio in respect of an Index Floating Amount Payer |
| | Period End Date, is subsequently corrected and |
| | published within 30 calendar days of the original |
| | publication, either party may notify the other |
| | party of (i) the correction and (ii) the amount |
| | (if any) that is payable as a result of such |
| | correction. Notification shall be in writing, |
| | shall reasonably confirm such correction and |
| | must be received not later than 30 calendar days |
| | following publication of such correction. Upon |
| | receipt of such notification, the party that |
| | originally either received or retained such |
| | amount shall, not later than three Business |
| | Days after receipt of that notice, pay to the |
| | other party that amount, together with interest |
| | on that amount at a rate per annum equal to |
| | the arithmetic average of the Federal Funds |
| | (effective) Rate, as published in the H.15 |
| | (519), for the period from and including the |
| | day on which a payment of the amount subject |
| | to such correction originally was paid, to but |
| | excluding the date of the refund or payment |
| | resulting from that correction. |
| Floating Amounts: | |
| Floating Rate | Party B |
| Payer: | |
| Floating Rate | The first calendar day of each month, commencing |
| Payer Period | on trade date and ending on the Termination Date. |
| End Dates: | |
| Delayed Payment: | 4 calendar days after each Index Floating Amount |
| | Payer Period End Date, subject to adjustment in |
| | accordance with the Modified Following Business |
| | Day Convention. |
| No Adjustment of | Applicable |
| Period End Dates: | |
| Floating Rate | SIFMA average weekly reset rate over 3 months |
| Option: | |
| Designated | 1 week |
| Maturity: | |
| Spread: | TBD |
| Floating Rate Day | Actual/Actual |
| Count Fraction: | |
| Reset Dates: | The first day of each Calculation Period |
| Business Days: | NY |
| Miscellaneous: | |
| Calculation | Party A |
| Agent: | |
| Office: | For the purposes of this Transaction, Party A |
| | is not a Multibranch Party, and the Office of |
| | Party B is its Head Office. |

What is claimed is:

1. A computer-implemented method comprising:
electronically receiving data regarding characteristics of a plurality of tax exempt municipal bonds;
electronically receiving data describing a plurality of rules for inclusion of said tax exempt municipal bonds in a municipal bond index;
constructing a municipal bond index by applying said rules to characteristics of said plurality of tax exempt municipal bonds; and
quoting a municipal swap having a reference index, wherein said reference index is said municipal bond index.

2. A method as in claim 1, wherein said swap is on a total return basis.

3. A method as in claim 1, wherein said rules comprise tax status.

4. A method as in claim 3, wherein said tax status relates to exemption from alternative minimum tax.

5. A method as in claim 1, wherein said swap is on a yield basis.

6. A method as in claim 1, wherein said municipal bond index comprises two sets of municipal bonds: a returns universe and a statistics universe.

7. A method as in claim 6, wherein said returns universe is adjusted only on a monthly basis.

8. A method as in claim 6, wherein said returns universe comprises municipal bonds whose value determines a value for said reference index.

9. A method as in claim 6, wherein composition of said statistics universe changes on a daily basis.

10. A method as in claim 6, wherein composition of said statistics universe accounts for changes due to one or more of new issuance, calls, rating changes, and remaining maturity.

11. A method as in claim 6, wherein at the end of each month, the current statistics universe becomes the returns universe for the coming month.

12. A computer system comprising:
a hardware component that electronically receives data regarding characteristics of a plurality of tax exempt municipal bonds;
a hardware component that electronically receives data describing a plurality of rules for inclusion of said tax exempt municipal bonds in a municipal bond index;
a hardware component that constructs a municipal bond index by applying said rules to characteristics of said plurality of tax exempt municipal bonds; and
a hardware component that quotes a municipal swap having a reference index, wherein said reference index is said municipal bond index, and wherein said hardware components may be, but are not necessarily, distinct from each other.

13. A system as in claim 12, wherein said swap is on a total return basis.

14. A system as in claim 12, wherein said rules comprise tax status.

15. A system as in claim 14, wherein said tax status relates to exemption from alternative minimum tax.

16. A system as in claim 12, wherein said swap is on a yield basis.

17. A system as in claim 12, wherein said municipal bond index comprises two sets of municipal bonds: a returns universe and a statistics universe.

18. A system as in claim 17, wherein said returns universe is adjusted only on a monthly basis.

19. A system as in claim 17, wherein said returns universe comprises municipal bonds whose value determines a value for said reference index.

20. A system as in claim 17, wherein composition of said statistics universe changes on a daily basis.

21. A system as in claim 17, wherein composition of said statistics universe accounts for changes due to one or more of new issuance, calls, rating changes, and remaining maturity.

22. A system as in claim 17, wherein at the end of each month, the current statistics universe becomes the returns universe for the coming month.

23. An apparatus comprising:
a first computer readable medium that stores data regarding characteristics of a plurality of tax exempt municipal bonds;
a second computer readable medium that stores data describing a plurality of rules for inclusion of said tax exempt municipal bonds in a municipal bond index;
a third computer readable medium that stores data describing a municipal bond index constructed by applying said rules to characteristics of said plurality of tax exempt municipal bonds; and
a fourth computer readable medium that stores one or more quotes regarding a municipal swap having a reference index, wherein said reference index is said municipal bond index, and wherein said computer readable mediums may be, but are not necessarily, distinct from each other.

24. An apparatus as in claim 23, wherein said swap is on a total return basis.

25. An apparatus as in claim 23, wherein said rules comprise tax status.

26. An apparatus as in claim 25, wherein said tax status relates to exemption from alternative minimum tax.

27. An apparatus as in claim 23, wherein said swap is on a yield basis.

28. An apparatus as in claim 23, wherein said municipal bond index comprises two sets of municipal bonds: a returns universe and a statistics universe.

29. An apparatus as in claim 28, wherein said returns universe is adjusted only on a monthly basis.

30. An apparatus as in claim 28, wherein said returns universe comprises municipal bonds whose value determines a value for said reference index.

31. An apparatus as in claim 28, wherein composition of said statistics universe changes on a daily basis.

32. An apparatus as in claim 28, wherein composition of said statistics universe accounts for changes due to one or more of new issuance, calls, rating changes, and remaining maturity.

33. An apparatus as in claim 28, wherein at the end of each month, the current statistics universe becomes the returns universe for the coming month.
